(19) United States
(12) Patent Application Publication
(10) Pub. No.: US 2026/0072387 A1
(43) Pub. Date: Mar. 12, 2026

(54) DISCHARGE DEVICE AND IMAGE FORMING APPARATUS

(71) Applicant: FUJIFILM Business Innovation Corp., Tokyo (JP)

(72) Inventors: Yuki KAWAZOE, Kanagawa (JP); Yuya Chonabayashi, Kanagawa (JP); Yasunobu Goto, Kanagawa (JP); Satoshi Watanabe, Kanagawa (JP); Suguru Goto, Kanagawa (JP); Yuki Kohno, Kanagawa (JP); Yoshinori Kodakari, Kanagawa (JP); Yasuhisa Fukuda, Kanagawa (JP)

(73) Assignee: FUJIFILM Business Innovation Corp., Tokyo (JP)

(21) Appl. No.: 19/040,457

(22) Filed: Jan. 29, 2025

(30) Foreign Application Priority Data
Sep. 9, 2024 (JP) 2024-155300

(51) Int. Cl. G03G 15/00

(52) U.S. Cl. CPC G03G 15/6529; G03G 15/6573; G03G 15/6582; G03G 2215/00426; G03G 2215/00616

(57) ABSTRACT

A discharge device includes a body cover to which a discharge tray onto which a recording medium is discharged from an apparatus body, a post-processing device that post-processes the recording medium discharged from the apparatus body, or a transport member that transports the recording medium to the post-processing device is detachably attached, a detection member that detects the recording medium discharged onto the discharge tray at a protruding position where at least a part of the detection member protrudes from the body cover, and a support member that supports the detection member such that the detection member moves between the protruding position and a storage position where the detection member is stored inside the apparatus body.

### CROSS-REFERENCE TO RELATED APPLICATIONS

This application is based on and claims priority under 35 USC 119 from Japanese Patent Application No. 2024-155300 filed Sep. 9, 2024.

### BACKGROUND

### (i) Technical Field

The present invention relates to a discharge device and an image forming apparatus.

### (ii) Related Art

JP2007-176676A discloses a sheet stacking device including a tray for stacking discharged paper, in which an angle of the paper in the tray can be changed. The angle is changed by changing an angle of a movable member provided on a paper stacking surface of the tray. The movable member may be a single member or a plurality of members, and, in the case of a plurality of members, the movable member to be operated is selected according to a size of the paper.

### SUMMARY

A discharge tray onto which a recording medium is discharged from an apparatus body, a post-processing device that post-processes the recording medium discharged from the apparatus body, or a transport member that transports the recording medium to the post-processing device is detachably attached to a body cover that covers the apparatus body.

Further, in a case where the discharge tray is attached to the body cover, a detection member that detects the recording medium discharged to the discharge tray is attached to the apparatus body. However, the detection member protrudes from the body cover. Therefore, in a case of detaching the discharge tray from the body cover and attaching the post-processing device or the transport member to the body cover, the detection member has to be detached from the apparatus body.

Aspects of non-limiting embodiments of the present disclosure relate to a discharge device that it is possible to attach a post-processing device or a transport member to a body cover without detaching a detection member from an apparatus body in a configuration in which the detection member protrudes from the body cover in a case where a discharge tray is attached to the body cover.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a discharge device including a body cover to which a discharge tray onto which a recording medium is discharged from an apparatus body, a post-processing device that post-processes the recording medium discharged from the apparatus body, or a transport member that transports the recording medium to the post-processing device is detachably attached, a detection member that detects the recording medium discharged onto the discharge tray at a protruding position where at least a part of the detection member protrudes from the body cover, and a support member that supports the detection member such that the detection member moves between the protruding position and a storage position where the detection member is stored inside the apparatus body.

### BRIEF DESCRIPTION OF THE DRAWINGS

Exemplary embodiment(s) of the present invention will be described in detail based on the following figures, wherein:

FIG. 1 is a schematic configuration diagram showing an image forming apparatus according to an exemplary embodiment of the present disclosure;

FIG. 2 is a schematic configuration diagram showing an image forming unit provided in the image forming apparatus according to the exemplary embodiment of the present disclosure;

FIG. 3 is an exploded perspective view showing a discharge tray and a body cover of a discharge device according to the exemplary embodiment of the present disclosure;

FIG. 4 is a perspective view showing a state where the discharge tray is attached to the body cover of the discharge device according to the exemplary embodiment of the present disclosure;

FIG. 5 is a front view showing a state where the discharge tray is attached to the body cover of the discharge device according to the exemplary embodiment of the present disclosure;

FIG. 6 is a schematic configuration diagram showing the image forming apparatus and a post-processing device according to the exemplary embodiment of the present disclosure;

FIG. 7 is an exploded perspective view showing a transport member and the body cover of the discharge device according to the exemplary embodiment of the present disclosure;

FIG. 8 is a perspective view showing a state where the transport member is attached to the body cover of the discharge device according to the exemplary embodiment of the present disclosure;

FIG. 9 is a front view showing a state where the transport member is attached to the body cover of the discharge device according to the exemplary embodiment of the present disclosure;

FIGS. 10A and 10B are front views showing a state where a detection member of the discharge device according to the exemplary embodiment of the present disclosure is moved to a storage position and a state where the detection member is moved to a protruding position; and

FIGS. 11A and 11B are side views showing a state where the detection member of the discharge device according to the exemplary embodiment of the present disclosure is moved to the storage position and a state where the detection member is moved to the protruding position.

### DETAILED DESCRIPTION

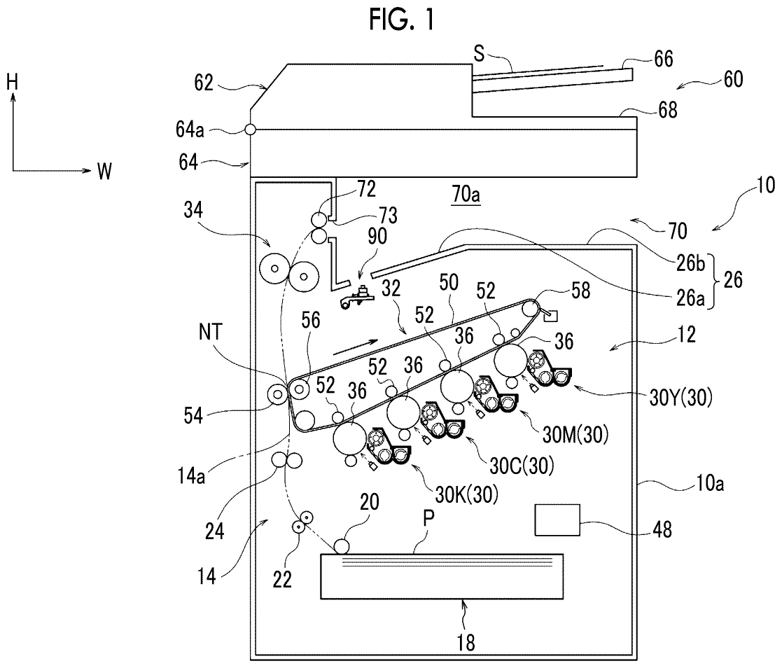

An example of a discharge device and an image forming apparatus according to an exemplary embodiment of the present disclosure will be described with reference to FIG. 1 to FIGS. 11A and 11B. In addition, an arrow H shown in each drawing indicates a vertical direction and an up-down direction of the discharge device and the image forming apparatus. An arrow W is orthogonal to the arrow H and indicates a width direction of the discharge device and the image forming apparatus in a horizontal direction. An arrow D is orthogonal to the arrow H and the arrow W and indicates a depth direction of the discharge device and the image forming apparatus in the horizontal direction.

### Overall Configuration of Image Forming Apparatus 10

As shown in FIG. 1, an image forming apparatus 10 includes an image reading section 60, an image forming section 12, and a transport section 14 that transports a sheet member P as a recording medium along a transport path 14a. Further, the image forming apparatus 10 includes an accommodating member 18 that accommodates the sheet member P and a control unit 48 that controls the entire apparatus. In addition, the image forming apparatus 10 includes a discharge device 70 that discharges the sheet member P on which a toner image is formed to an outside of an apparatus body 10a.

In this configuration, in the image forming apparatus 10, the sheet member P accommodated in the accommodating member 18 is transported by the transport section 14 along the transport path 14a. Further, a toner image is formed by the image forming section 12 based on image data read by the image reading section 60. In addition, the toner image is formed on the sheet member P transported. Then, the sheet member P is discharged to the outside of the apparatus body 10a by the discharge device 70.

### Image Forming Section 12

As shown in FIG. 1, the image forming section 12 includes a plurality of toner image forming units 30 that form toner images of respective colors and a transfer unit 32 that transfers the toner images formed by the toner image forming units 30 onto the sheet member P. Further, the image forming section 12 includes a fixing device 34 that fixes the toner images, which are transferred onto the sheet member P by the transfer unit 32, to the sheet member P.

Toner Image Forming Unit 30 The plurality of toner image forming units 30 are provided to form toner images for respective colors. In the present exemplary embodiment, toner image forming units 30Y, 30M, 30C, and 30K for a total of four colors of yellow (Y), magenta (M), cyan (C), and black (K) are provided. In the following description, in a case where there is no need to distinguish between yellow (Y), magenta (M), cyan (C), and black (K), Y, M, C, and K attached as the reference numerals are omitted.

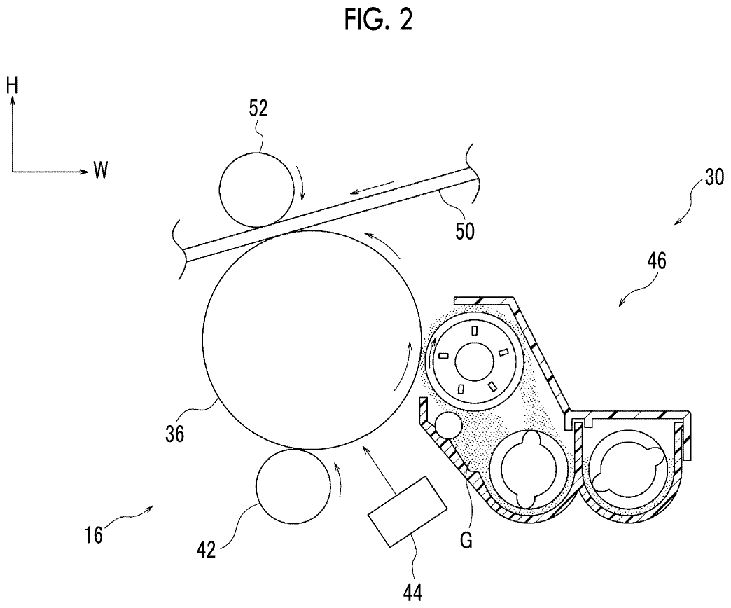

The toner image forming units 30 of the respective colors have the basically same configuration except for a toner to be used. As shown in FIG. 2, the toner image forming unit 30 includes an image holder unit 16 including a rotating image holder 36 that has a cylindrical shape and a charger 42 that charges the image holder 36. Further, the toner image forming unit 30 includes an exposure device 44 that irradiates the charged image holder 36 with exposure light to form an electrostatic latent image and a developing device 46 that develops the electrostatic latent image by using a developer G containing a toner as a toner image. As a result, the toner image forming unit 30 of each color forms an image of each color using a toner of each color.

In addition, as shown in FIG. 1, the image holder 36 of each color is in contact with a transfer belt 50 (described in detail below) that moves circumferentially. In a circumferential direction (see an arrow in the drawing) of the transfer belt 50, the yellow (Y), magenta (M), cyan (C), and black (K) toner image forming units 30 are arranged in turn from an upstream side.

### Transfer Unit 32

As shown in FIG. 1, the transfer unit 32 includes a transfer belt 50. Further, the transfer unit 32 includes primary transfer rolls 52 each of which is disposed on an opposite side of the image holder 36 of each color with the transfer belt 50 interposed therebetween and transfers a toner image formed on the image holder 36 of each color onto the transfer belt 50.

In addition, the transfer unit 32 includes a winding roll 56 around which the transfer belt 50 is wound, and a drive roll 58 around which the transfer belt 50 is wound and which transmits a rotational force to the transfer belt 50. As a result, the transfer belt 50 is circumferentially driven in an arrow direction in the drawing.

Further, the transfer unit 32 includes a secondary transfer roll 54 that is disposed on an opposite side of the winding roll 56 with the transfer belt 50 interposed therebetween and that transfers, onto the sheet member P, the toner image transferred onto the transfer belt 50. A transfer nip NT where the toner image is transferred onto the sheet member P is formed between the secondary transfer roll 54 and the transfer belt 50.

### Fixing Device 34

As shown in FIG. 1, the fixing device 34 is disposed on a downstream side of the transfer nip NT in a transport direction of the sheet member P. The fixing device 34 heats and pressurizes the toner image transferred onto the sheet member P to fix the toner image to the sheet member P.

In this configuration, the toner image is primarily transferred onto the transfer belt 50 by the primary transfer rolls 52 in order of yellow (Y), magenta (M), cyan (C), and black (K). In addition, the toner image is transferred from the transfer belt 50 by the secondary transfer roll 54 onto the sheet member P transported while being interposed between the transfer belt 50 and the secondary transfer roll 54.

Further, the sheet member P onto which the toner image is transferred is transported toward the fixing device 34. Then, the fixing device 34 fixes the toner image transferred onto the sheet member P to the sheet member P.

### Transport Section 14

As shown in FIG. 1, the transport section 14 includes a feeding roll 20 that feeds the sheet member P accommodated in the accommodating member 18 to the transport path 14a. In addition, the transport section 14 includes a prevention roll 22 that prevents double-feeding of the sheet member P fed by the feeding roll 20. Further, the transport section 14 includes an adjustment roll 24 that adjusts a timing of the sheet member P being fed to the transfer nip NT.

### Discharge Device 70

The discharge device 70 includes a discharge roll 72 that is disposed on the downstream side of the fixing device 34 in the transport direction of the sheet member P, and a body cover 26 that constitutes a part of the apparatus body 10a and that covers the transfer unit 32 from above.

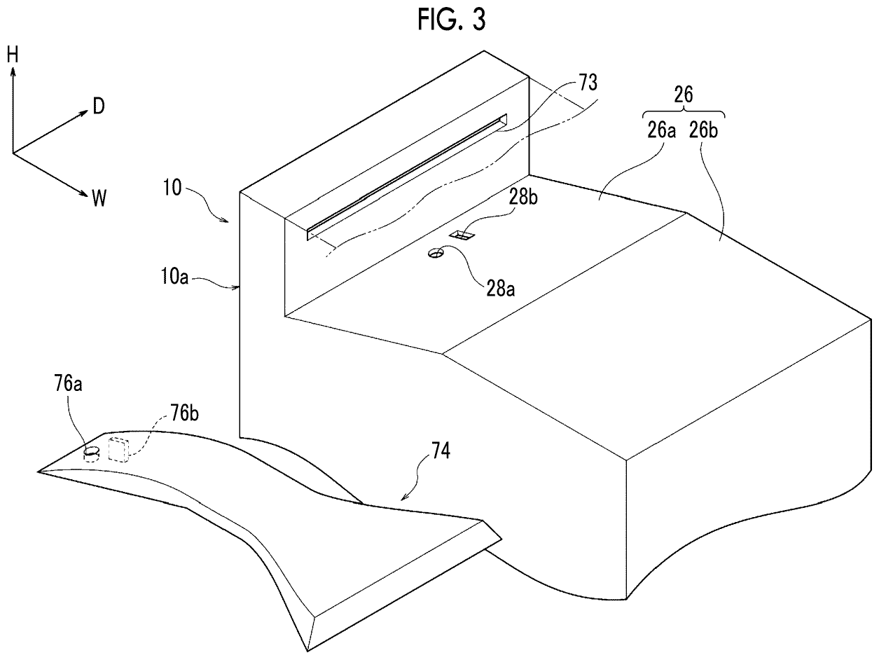

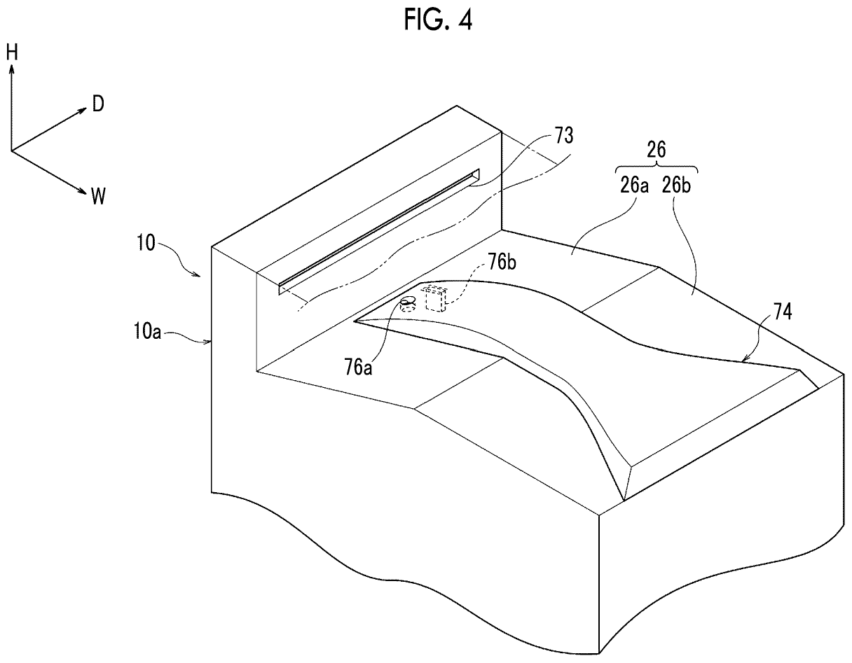

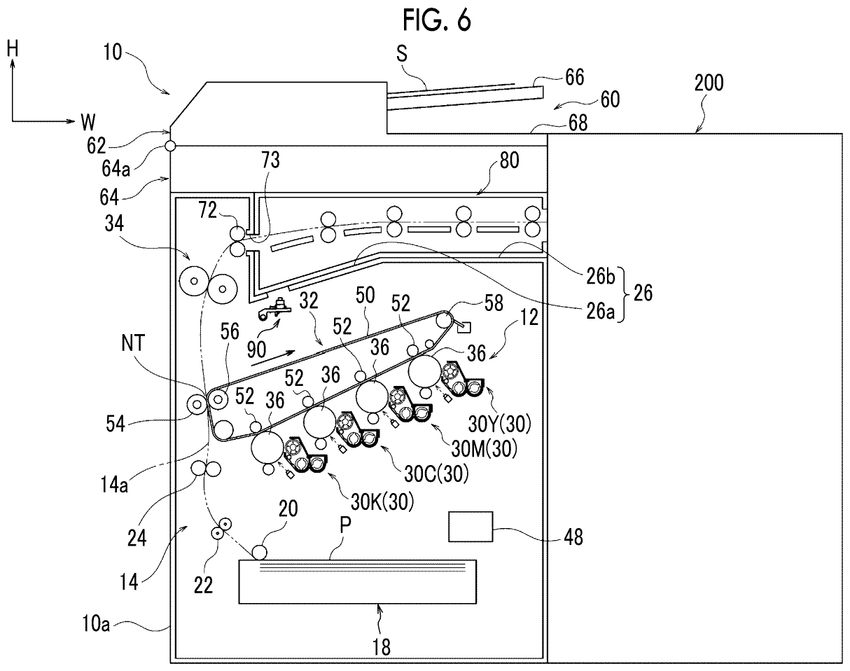

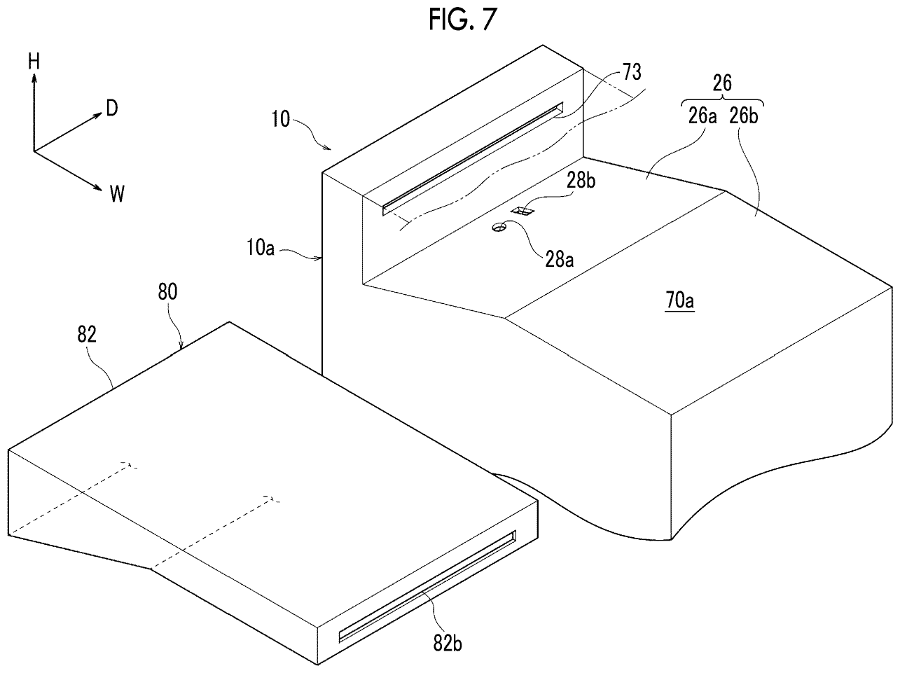

In addition, a discharge tray 74 (see FIG. 4) onto which the sheet member P is discharged from the apparatus body 10a or a transport member 80 (see FIG. 6) that transports the sheet member P discharged from the apparatus body 10a to a post-processing device 200 is detachably attached to the body cover 26. The discharge device 70, the discharge tray 74 (see FIG. 3), and the transport member 80 (see FIG. 7) will be described in detail below.

### Image Reading Section 60

As shown in FIG. 1, the image reading section 60 is disposed above the discharge device 70 from which the sheet member P is discharged. The image reading section 60 includes a document transport section 62 and a document reading section 64. In addition, the document transport section 62 and the document reading section 64 are connected by a hinge portion 64a provided in the document reading section 64. The document transport section 62 rotates about the hinge portion 64a, thereby opening the document reading section 64 upward.

Further, the image reading section 60 includes a paper feed table 66 on which a document S to be supplied to the document transport section 62 is stacked, and a discharge tray 68 onto which the document S read by the document transport section 62 is discharged.

In this configuration, the document reading section 64 reads an image of the document S transported by the document transport section 62 and an image of the document S placed on a platen glass (not shown) on an upper surface of the document reading section 64.

### Major Configuration

Next, the discharge device 70, the discharge tray 74, and the transport member 80 will be described.

The discharge device 70 includes the discharge roll 72 and the body cover 26 to which the discharge tray 74 or the transport member 80 is detachably attached. Further, the discharge device 70 includes a detection unit 90 for detecting the sheet member P discharged onto the discharge tray 74.

### Body Cover 26 of Discharge Device 70

As shown in FIGS. 1 and 3, the body cover 26 is located downstream in a discharge direction of the sheet member P with respect to a discharge port 73 through which the sheet member P is discharged by the discharge roll 72, and covers the apparatus body 10a from above. The body cover 26 is formed with an inclined surface 26a that is inclined such that one side in the width direction is upward as viewed in the depth direction. In addition, the body cover 26 is formed with an upward surface 26b that is disposed to be continuous with the inclined surface 26a and that faces upward. Further, as shown in FIG. 3, a circular hole 28a that penetrates the body cover 26 in the up-down direction is formed in a central portion of the inclined surface 26a in the depth direction. In addition, a rectangular hole 28b that penetrates the body cover 26 in the up-down direction is formed on a back side of the circular hole 28a in the depth direction on the inclined surface 26a. A space formed between the body cover 26 and the document reading section 64 in the up-down direction serves as a discharge space 70a.

The detection unit 90 of the discharge device 70 will be described after the discharge tray 74 and the transport member 80 (see FIG. 1).

### Discharge Tray 74

As shown in FIGS. 3 and 4, the discharge tray 74 is detachably attached to the body cover 26 from above by an attachment portion (not shown). In addition, a depth length of an upstream portion of the discharge tray 74 in the discharge direction is shorter than a depth length of a downstream portion of the discharge tray 74 in the discharge direction.

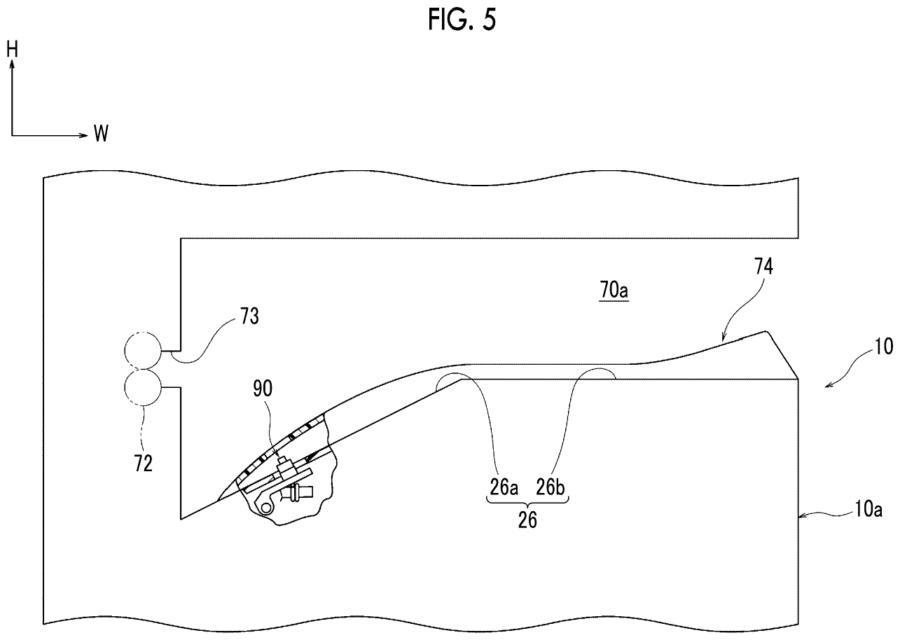

Further, as shown in FIG. 5, the upstream portion of the discharge tray 74 in the discharge direction is curved to be convex as viewed in the depth direction. On the other hand, the downstream portion of the discharge tray 74 in the discharge direction is curved to be concave.

In addition, as shown in FIGS. 3 and 4, a circular hole 76a that penetrates the discharge tray 74 in the up-down direction is formed in the upstream portion of the discharge tray 74 in the discharge direction. Further, a protrusion 76b that protrudes to the body cover 26 side is formed in a portion of the discharge tray 74 on the back side in the depth direction with respect to the circular hole 76a.

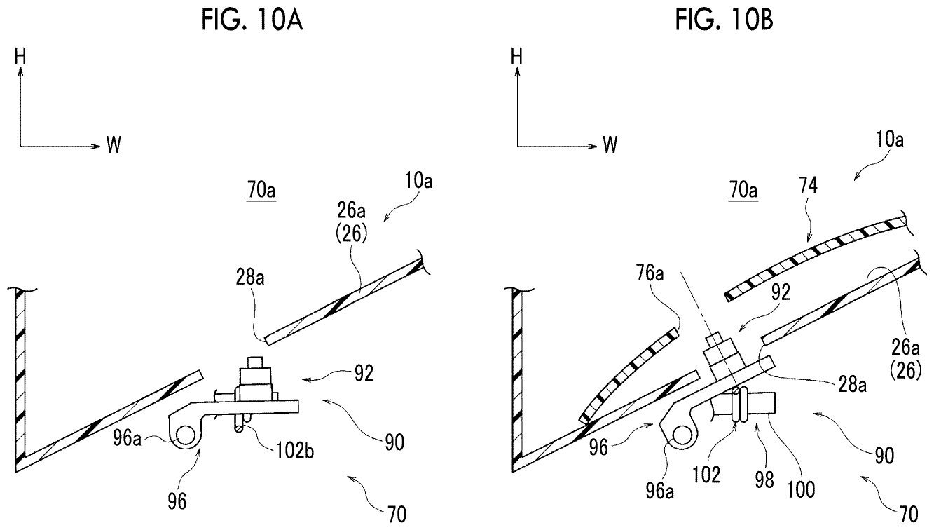

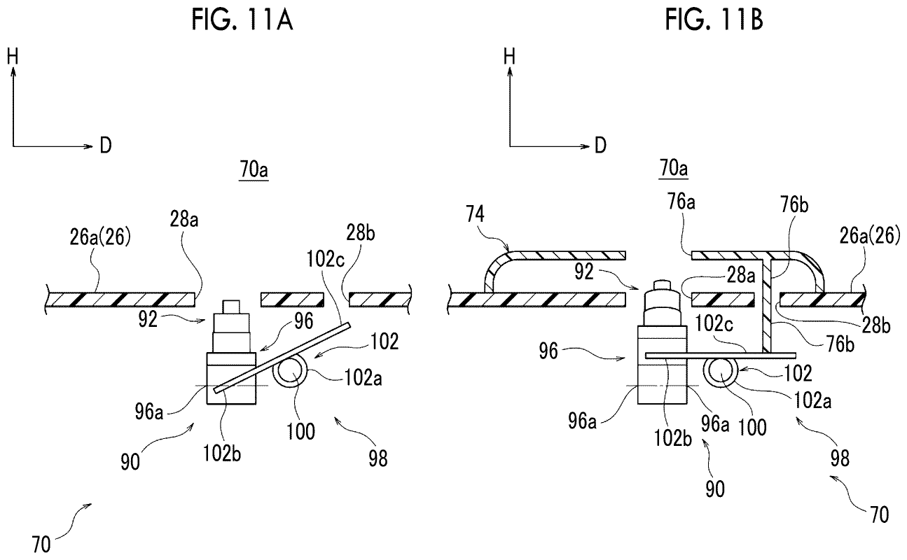

In this configuration, in a state where the discharge tray 74 is attached to the body cover 26, the circular hole 76a of the discharge tray 74 and the circular hole 28a of the body cover 26 are connected in a penetration direction (see FIG. 10B). Further, in a state where the discharge tray 74 is attached to the body cover 26, the protrusion 76b of the discharge tray 74 is inserted into the rectangular hole 28b of the body cover 26 (see FIG. 11B).

### Transport Member 80

As shown in FIG. 6, the transport member 80 is a member that transports the sheet member P discharged from the discharge port 73 by the discharge roll 72 to the post-processing device 200 disposed on one side in the width direction of the image forming apparatus 10. Examples of the post-processing device 200 include a stapler, a puncher, a saddle stitcher, a Z-folder, and a tri-folder.

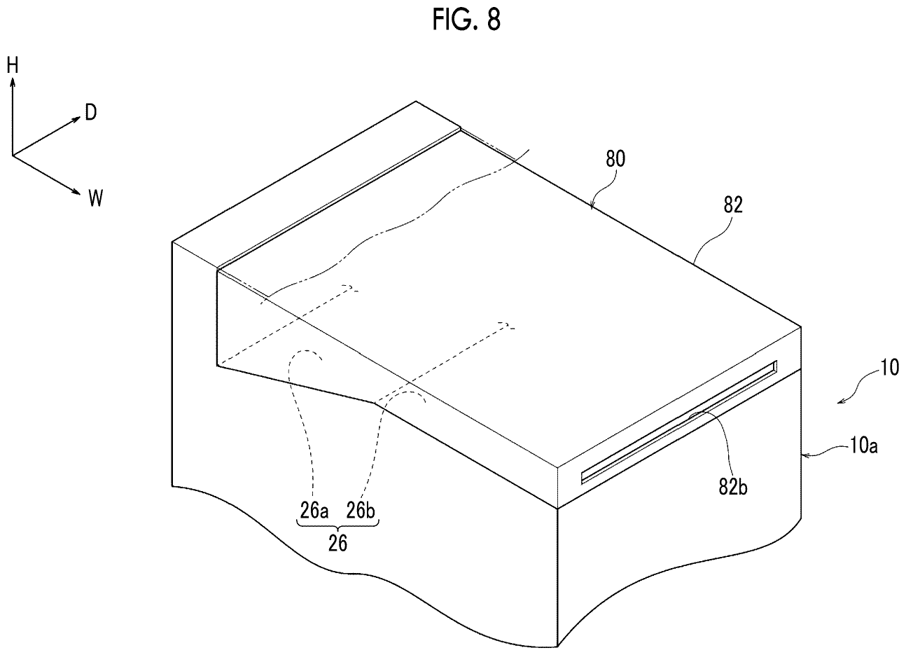

As shown in FIGS. 7 and 8, the transport member 80 is detachably attached to the body cover 26 from above by an attachment portion (not shown). The transport member 80 is disposed over the entire discharge space 70a (see FIG. 1).

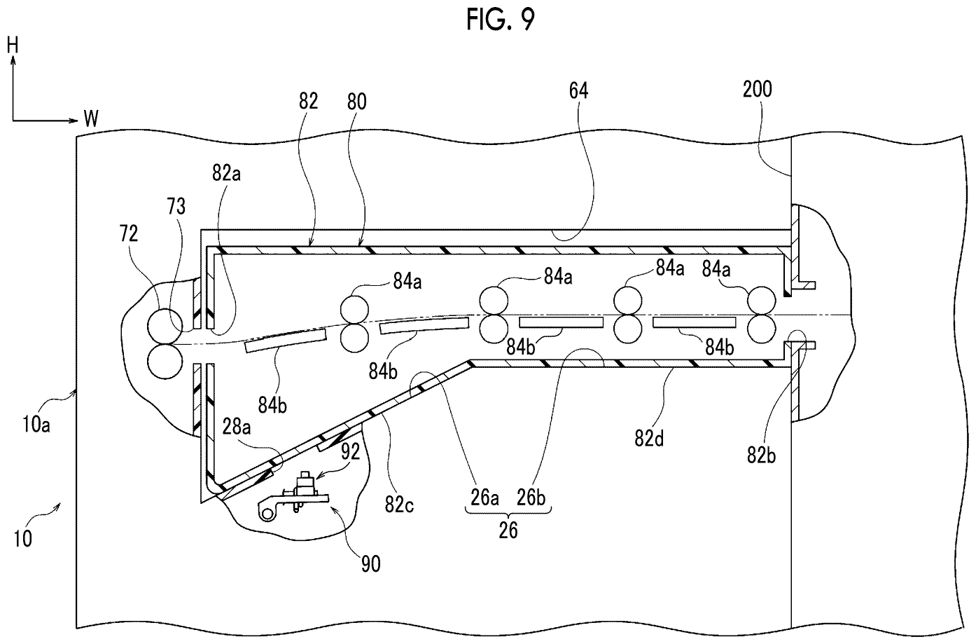

As shown in FIG. 9, a housing 82 of the transport member 80 is formed with an inlet 82a for receiving the sheet member P discharged from the discharge port 73 by the discharge roll 72 and an outlet 82b for feeding the sheet member P to the post-processing device 200.

Further, the housing 82 is formed with an inclined surface 82c that faces the inclined surface 26a of the body cover 26 and that is formed along the inclined surface 26a. In addition, the housing 82 is formed with a downward surface 82d that faces the upward surface 26b of the body cover 26 and that is formed along the upward surface 26b. Here, at least the inclined surface 82c is colored black. In the present exemplary embodiment, the black color is a color of which a chromaticity deviation from an achromatic point (x=0.333, y=0.333, Y=0) is within 100 in terms of a color difference ΔE.

In addition, a plurality of rolls 84a and a plurality of guide members 84b are disposed inside the housing 82.

### Detection Unit 90 of Discharge Device 70

As shown in FIGS. 10A and 10B, the detection unit 90 includes a detection member 92 that detects the sheet member P discharged onto the discharge tray 74, and a support member 96 that supports the detection member 92. Further, the detection unit 90 includes a movement member 98 that acts on the support member 96 to move the detection member 92.

### Detection Member 92 and Support Member 96

The detection member 92 shown in FIGS. 10A and 10B is an optical sensor, and detects the sheet member P by receiving light that is emitted and reflected by an object.

The support member 96 is disposed below the inclined surface 26a of the body cover 26 and extends in the width direction. Further, the detection member 92 is attached to one side portion (right side in the drawing) of the support member 96 in the width direction so as to face upward.

A rotation shaft portion 96a that is attached to a frame (not shown) and that extends in the depth direction is provided on the other side portion (left side in the drawing) of the support member 96 in the width direction. The support member 96 that supports the detection member 92 rotationally moves about the rotation shaft portion 96a.

Specifically, a rotation range of the support member 96 is restricted by a stopper (not shown). The support member 96 rotationally moves about the rotation shaft portion 96a, thereby allowing the detection member 92 to move between a storage position (see FIG. 10A) where the detection member 92 is stored inside the apparatus body 10a and a protruding position (see FIG. 10B) where at least a part of the detection member 92 protrudes from the circular hole 28a.

Further, the detection member 92 that has moved to the protruding position is covered with the discharge tray 74, faces the circular hole 76a of the discharge tray 74 in a protruding direction, and detects the sheet member P discharged onto the discharge tray 74.

### Movement Member 98

As shown in FIGS. 11A and 11B, the movement member 98 includes a cylindrical portion 100 attached to a frame (not shown) and a winding spring 102 wound around the cylindrical portion 100.

The cylindrical portion 100 is disposed on the back side in the depth direction with respect to the support member 96 and extends in the width direction. Then, the cylindrical portion 100 is inserted into a winding portion 102a of the winding spring 102. Further, a cantilever portion 102b extending from one side of the winding portion 102a to the support member 96 side is inclined in the depth direction and is disposed below the support member 96 in a no-load state, as shown in FIG. 11A. On the other hand, a cantilever portion 102c extending from the other side of the winding portion 102a to a side opposite to the support member 96 is disposed below the rectangular hole 28b. In this state, the detection member 92 is moved to the storage position as shown in FIG. 11A.

### Action of Major Configuration

Next, an action of the discharge device 70 will be described.

In a state where nothing is attached to the body cover 26 of the discharge device 70, as shown in FIG. 11A, no external force is applied to the winding spring 102 of the movement member 98. Therefore, the winding spring 102 is disposed at an initial position inclined in the depth direction. Further, the detection member 92 is moved to the storage position as shown in FIG. 10A and FIG. 11A.

In this state, in a case where the discharge tray 74 is attached to the body cover 26, as shown in FIG. 11B, the protrusion 76b of the discharge tray 74 is inserted into the rectangular hole 28b. Then, the protrusion 76b presses the cantilever portion 102c of the winding spring 102 downward.

In a case where the cantilever portion 102c is pressed downward, the winding spring 102 rotates about the cylindrical portion 100, and the cantilever portion 102b of the winding spring 102 is lifted. As a result, the cantilever portion 102b lifts the support member 96 from below, and the support member 96 rotates about the rotation shaft portion 96a. Further, as the support member 96 rotates, the detection member 92 moves to the protruding position as shown in FIG. 10B and FIG. 11B. As a result, the detection member 92 detects the sheet member P discharged onto the discharge tray 74.

On the other hand, in a case where the discharge tray 74 is detached from the body cover 26 in this state, as shown in FIG. 11A, a pressing force (restraining force) of the protrusion 76b against the winding spring 102 is released. Accordingly, the cantilever portion 102b of the winding spring 102 is pressed downward by the weight of the support member 96, and the winding spring 102 rotates about the cylindrical portion 100. Then, as the winding spring 102 rotates, the winding spring 102 returns to the initial position. In addition, the support member 96 rotates about the rotation shaft portion 96a due to the weight of the support member 96, and the detection member 92 moves to the storage position as shown in FIG. 10A and FIG. 11A.

In a case where the detection member 92 moves to the storage position, it is possible to attach the transport member 80 to the body cover 26 without detaching the detection member 92. In addition, light emitted from the detection member 92 that has moved to the storage position is emitted to the inclined surface 82c of the housing 82 of the transport member 80 (see FIG. 9). Here, the expression “without detaching the detection member 92” means that the detection member 92 is not detached by being physically separated from the apparatus body 10a.

### Summary

As described above, in the discharge device 70, the detection member 92 is supported to be movable between the protruding position and the storage position. As a result, in the configuration in which the detection member 92 protrudes from the body cover 26 in a case where the discharge tray 74 is attached to the body cover 26, the transport member 80 is attached to the body cover 26 without detaching the detection member 92 from the apparatus body 10a.

In addition, in the discharge device 70, the discharge tray 74 is attached to the body cover 26 in a state where the detection member 92 is moved to the storage position. Then, the movement member 98 acts on the support member 96 to move the detection member 92 to the protruding position. As a result, time and effort of an operator to move the detection member 92 from the storage position to the protruding position are saved.

In addition, in the discharge device 70, in a case where the discharge tray 74 is attached to the body cover 26, the protrusion 76b of the discharge tray 74 presses the cantilever portion 102c of the winding spring 102 downward. As a result, the winding spring 102 rotates about the cylindrical portion 100, and the cantilever portion 102b of the winding spring 102 is lifted. Then, the cantilever portion 102b lifts the support member 96 from below, the support member 96 rotates about the rotation shaft portion 96a, and the detection member 92 moves to the protruding position. In this way, the detection member 92 moves from the storage position to the protruding position without using electric power.

In addition, in the discharge device 70, in a case where the discharge tray 74 is detached from the body cover 26 in a state where the detection member 92 is moved to the protruding position, the movement member 98 acts on the support member 96 to move the detection member 92 to the storage position. As a result, time and effort of the operator to move the detection member 92 from the protruding position to the storage position are saved.

In addition, in the discharge device 70, in a case where the discharge tray 74 is detached from the body cover 26, the pressing force (restraining force) of the protrusion 76b against the winding spring 102 is released. As a result, the cantilever portion 102b of the winding spring 102 is pressed downward by the weight of the support member 96, and the winding spring 102 rotates. Then, as the support member 96 rotates due to the weight of the support member 96, the detection member 92 moves to the storage position. In this way, the detection member 92 moves from the protruding position to the storage position without using electric power.

In addition, in the discharge device 70, a portion irradiated with light by the detection member 92 is colored black in a state where the detection member 92 is moved to the storage position. As a result, even in a case where irradiation with light is performed from the detection member 92 that has moved to the storage position, erroneous detection of the detection member 92 is suppressed.

In addition, in the discharge device 70, in a state where the detection member 92 is moved to the storage position, the inclined surface 82c colored black in the housing 82 of the transport member 80 is irradiated with light from the detection member 92. As a result, the detection function of the detection member 92 is ensured without using a dedicated member colored black.

In addition, the image forming apparatus 10 includes the discharge device 70, so that the post-processing device 200 is attached to the image forming apparatus 10 without detaching the detection member 92 from the apparatus body 10a.

The present disclosure has been described in detail with respect to a specific exemplary embodiment. However, the present disclosure is not limited to such an exemplary embodiment, and it is apparent to those skilled in the art that various other exemplary embodiments can be made within the scope of the present disclosure. For example, in the above-described exemplary embodiment, the discharge tray 74 or the transport member 80 is attached to the body cover 26, but a post-processing device that processes the discharged sheet member P may be attached to the body cover 26.

In addition, in the above-described exemplary embodiment, the inclined surface 82c of the housing 82 irradiated with light by the detection member 92 is colored black in a state where the detection member 92 is moved to the storage position. However, in a case where other portions are irradiated with light from the detection member 92, the other portions need only be colored black.

In the above-described exemplary embodiment, the detection member 92 is moved by the action of the movement member 98 from the discharge tray 74, but the detection member may be moved by an electrical signal. However, in this case, the action exerted by the movement of the detection member 92 through the action of the movement member 98 from the discharge tray 74 is not achieved.

(((1)))

A discharge device comprising:
a body cover to which a discharge tray onto which a recording medium is discharged from an apparatus body, a post-processing device that post-processes the recording medium discharged from the apparatus body, or a transport member that transports the recording medium to the post-processing device is detachably attached;
a detection member that detects the recording medium discharged onto the discharge tray at a protruding position where at least a part of the detection member protrudes from the body cover; and
a support member that supports the detection member such that the detection member moves between the protruding position and a storage position where the detection member is stored inside the apparatus body.
   (((2)))

The discharge device according to (((1))), further comprising:
a movement member that acts on the support member to move the detection member to the protruding position in a case where the discharge tray is attached to the body cover in a state where the detection member is moved to the storage position.
   (((3)))

The discharge device according to (((2))),
wherein the support member has a rotation shaft portion, and the movement member rotates the support member about the rotation shaft portion by being pressed from the discharge tray in a case where the discharge tray is attached to the body cover, and moves the detection member in the storage position to the protruding position.
   (((4)))

The discharge device according to any one of (((1))) to (((3))), further comprising:
a movement member that acts on the support member to move the detection member to the storage position in a case where the discharge tray is detached from the body cover in a state where the detection member is moved to the protruding position.
   (((5)))

The discharge device according to (((4))),
wherein the support member has a rotation shaft portion, and
the movement member rotates the support member about the rotation shaft portion by releasing a restraining force of the discharge tray in a case where the discharge tray is detached from the body cover, and moves the detection member in the protruding position to the storage position.
   (((6)))

The discharge device according to any one of (((1))) to (((5))),
wherein the detection member is an optical sensor, and
a portion irradiated with light by the detection member is colored black in a state where the detection member is moved to the storage position.
   (((7)))

The discharge device according to (((6))),
wherein, in a state where the detection member is moved to the storage position and the post-processing device or the transport member is attached to the body cover, a housing of the post-processing device or the transport member is irradiated with light by the detection member, and
a portion of the housing that is irradiated with the light is colored black.
   (((8)))

An image forming apparatus comprising:
an image forming section that forms an image on a recording medium; and
the discharge device according to any one of (((1))) to (((7))) that discharges the recording medium on which the image is formed from the apparatus body.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A discharge device comprising:
a body cover to which a discharge tray onto which a recording medium is discharged from an apparatus body, a post-processing device that post-processes the recording medium discharged from the apparatus body, or a transport member that transports the recording medium to the post-processing device is detachably attached;
a detection member that detects the recording medium discharged onto the discharge tray at a protruding position where at least a part of the detection member protrudes from the body cover; and
a support member that supports the detection member such that the detection member moves between the protruding position and a storage position where the detection member is stored inside the apparatus body.

2. The discharge device according to claim 1, further comprising:
a movement member that acts on the support member to move the detection member to the protruding position in a case where the discharge tray is attached to the body cover in a state where the detection member is moved to the storage position.

3. The discharge device according to claim 2,
wherein the support member has a rotation shaft portion, and
the movement member rotates the support member about the rotation shaft portion by being pressed from the discharge tray in a case where the discharge tray is attached to the body cover, and moves the detection member in the storage position to the protruding position.

4. The discharge device according to claim 1, further comprising:
a movement member that acts on the support member to move the detection member to the storage position in a case where the discharge tray is detached from the body cover in a state where the detection member is moved to the protruding position.

5. The discharge device according to claim 4,
wherein the support member has a rotation shaft portion, and
the movement member rotates the support member about the rotation shaft portion by releasing a restraining force of the discharge tray in a case where the discharge tray is detached from the body cover, and moves the detection member in the protruding position to the storage position.

6. The discharge device according to claim 1,
wherein the detection member is an optical sensor, and
a portion irradiated with light by the detection member is colored black in a state where the detection member is moved to the storage position.

7. The discharge device according to claim 6,
wherein, in a state where the detection member is moved to the storage position and the post-processing device or the transport member is attached to the body cover, a housing of the post-processing device or the transport member is irradiated with light by the detection member, and
a portion of the housing that is irradiated with the light is colored black.

8. An image forming apparatus comprising:
an image forming section that forms an image on a recording medium; and
the discharge device according to claim 1 that discharges the recording medium on which the image is formed from the apparatus body.

9. An image forming apparatus comprising:
an image forming section that forms an image on a recording medium; and
the discharge device according to claim 2 that discharges the recording medium on which the image is formed from the apparatus body.

10. An image forming apparatus comprising:
an image forming section that forms an image on a recording medium; and
the discharge device according to claim 3 that discharges the recording medium on which the image is formed from the apparatus body.

11. An image forming apparatus comprising:
an image forming section that forms an image on a recording medium; and
the discharge device according to claim 4 that discharges the recording medium on which the image is formed from the apparatus body.

12. An image forming apparatus comprising:
an image forming section that forms an image on a recording medium; and
the discharge device according to claim 5 that discharges the recording medium on which the image is formed from the apparatus body.

13. An image forming apparatus comprising:
an image forming section that forms an image on a recording medium; and
the discharge device according to claim 6 that discharges the recording medium on which the image is formed from the apparatus body.

14. An image forming apparatus comprising:
an image forming section that forms an image on a recording medium; and
the discharge device according to claim 7 that discharges the recording medium on which the image is formed from the apparatus body.
